(19) United States
(12) Patent Application Publication
(10) Pub. No.: US 2019/0078611 A1
(43) Pub. Date: Mar. 14, 2019

(54) BALL STUD

(71) Applicant: Peninsula Components, Inc. dba Pencom, San Carlos, CA (US)

(72) Inventor: Gregg Vincent Summers, Scottsdale, AZ (US)

(21) Appl. No.: 15/699,169

(22) Filed: Sep. 8, 2017

(51) Int. Cl. F16C 11/06

(52) U.S. Cl. CPC F16C 11/0604

(57) ABSTRACT

A ball stud having an integrated washer or chamfered corners.

### BACKGROUND

This disclosure relates generally to the field of mechanical fasteners, and more specifically, to a ball stud having either an integrated washer face or chamfered corners.

A ball stud is a well-known mechanical fastener generally used with a mating receptacle to secure two items together, such as sheet metal panels. For example, FIG. 1 shows a first panel 10 having a ball stud clip 12 affixed to the panel, e.g., with countersunk rivets 13. The ball stud clip 12 has a central opening 14 with side arms 15 biased inward toward each other to provide a frictional resistance to insertion of the ball stud 22, and to hold the ball stud in place once inserted.

FIG. 2 shows a second panel 20 having the ball stud 22 affixed to the panel. The ball stud 22 has a male configuration, e.g., with a threaded shaft 23 that extends through a hole 21 in the panel 20, and a nut 24 secured onto the threaded shaft. It may be desirable to install a washer 25 between the head of the female threaded nut 24 and the sheet 20. In FIG. 3, the panels 10 and 20 are coupled together by snapping the ball stud 22 into the opening 14 of the ball stud clip 12.

Alternatively, the ball stud could have a female configuration (not shown), with internal threads, and a corresponding threaded male fastener that inserts through a hole in the panel into the internally threaded ball stud. Likewise, it may be desirable to install a washer between the head of the male threaded fastener and the sheet.

A standard hex nut is commonly used with the male thread ball stud, and these nuts typically have the corners chamfered. A screw with a circular washer would be typically used with a female thread ball stud. In these installations, the ball studs are held stationary and the nut or screw is turned so the stud corners do not scratch the surface of the sheet. However, customers generally prefer to use self-clinching hardware wherever practical to reduce the amount of “loose” hardware. Thus, a male thread ball stud may be used with a self-clinching nut and the female thread ball stud with a self-clinching stud. In these cases, the self-clinching nut and stud are affixed to the sheet metal and the ball studs are turned. Thus, there is a potential for the hexagonal corners of the ball stud to gouge the sheet metal. Thus, it would be desirable to modify the ball stud such that it will not scratch the panel upon installation.

### BRIEF DESCRIPTION OF THE DRAWINGS

FIG. 1 is a plan view of a first panel having a conventional ball stud clip installed.

FIG. 2 is a plan view of a second panel having a conventional ball stud installed.

FIG. 3 is a plan view of the first panel and second panel coupled together by inserting the conventional ball stud of the second panel into the conventional ball stud clip of the first panel.

FIGS. 4-5 are perspective views of a ball stud with male threads and a washer face according to a first embodiment

FIG. 6 is a side plan view of the ball stud of FIGS. 4-5.

FIG. 7 is a bottom plan view of the ball stud of FIG. 6.

FIGS. 8-9 are perspective views of a ball stud with female threads and a washer face according to a second embodiment

FIG. 10 is a side plan view of the ball stud of FIGS. 8-9.

FIG. 11 is a bottom plan view of the ball stud of FIG. 10.

FIGS. 12-13 are perspective views of a ball stud with male threads and chamfered corners according to a third embodiment

FIG. 14 is a side plan view of the ball stud of FIGS. 12-13.

FIG. 15 is a bottom plan view of the ball stud of FIG. 14.

FIGS. 16-17 are perspective views of a ball stud with female threads and and chamfered corners according to a fourth embodiment

FIG. 18 is a side plan view of the ball stud of FIGS. 16-17.

FIG. 19 is a bottom plan view of the ball stud of FIG. 18.

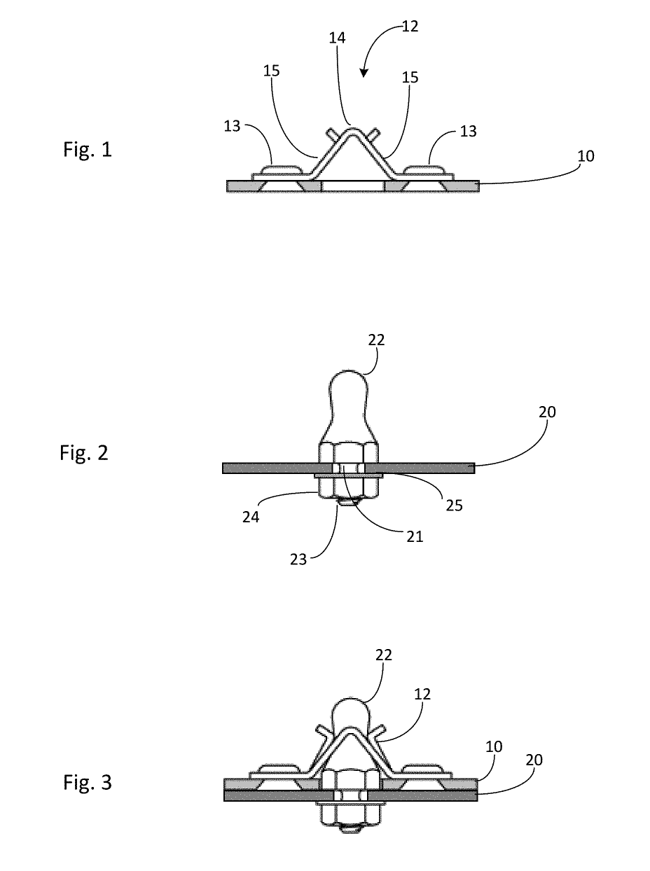

### DETAILED DESCRIPTION

A ball stud is formed to have an integrated washer face or chamfered corners on the hexagonal base in order to avoid gouging or scratching the surface of a sheet metal panel.

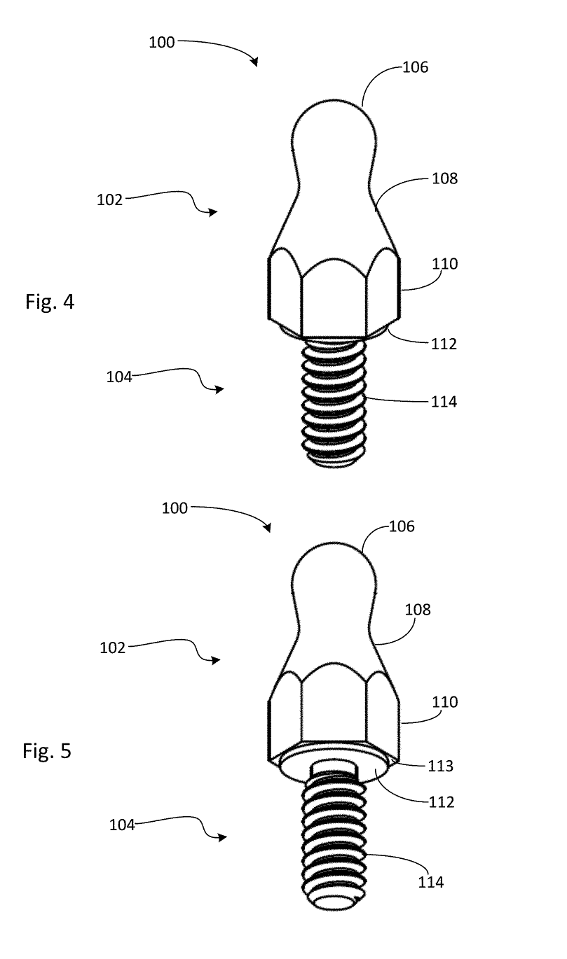

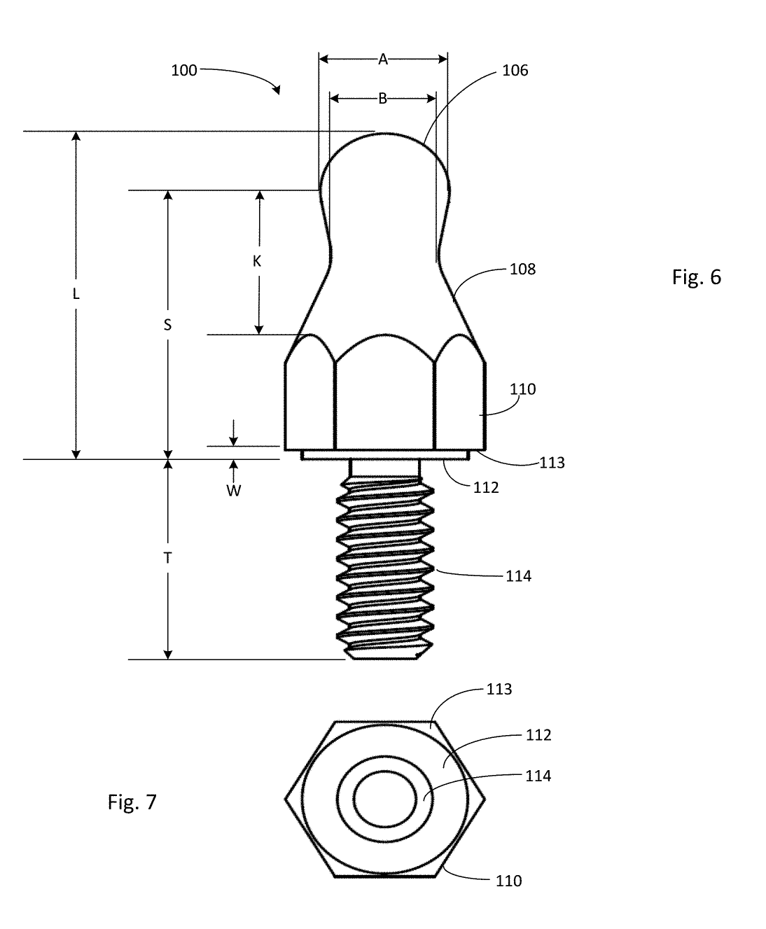

Referring to FIGS. 4-7, a first embodiment of a ball stud 100 in a male configuration is illustrated. Preferably, the ball stud 100 is a single integrated device machined from a single piece of hexagonal bar stock, e.g., made from carbon steel or stainless steel, to have a body portion 102 and a thread portion 104. For example, starting with a length of 0.25 inch bar stock, material is cut away using a lathe to form each of the features of the ball stud 100 as shown in FIGS. 4-7. Thus, the body portion 102 of the ball stud 100 is machined to form a narrow rounded knob 106 on the top, and a wider shoulder portion 108 in the middle that makes a smooth transition from the knob to a hip or base 110 formed by the remaining hex bar stock in the central portion of the ball stud. Between the hip 110 and the threaded portion 104, an annular flat washer 112 is formed.

The threaded portion 104 of the ball stud 100 is first machined to remove material and form a shank having a reduced diameter, and then the shank is cut/threaded using an appropriate die to form male threads 114.

In a typical construction, the full length L of the body portion 102 is measured from the top of the knob 106 to the bottom of the washer 112 and can be varied from approximately 0.42 inches to 0.63 inches (±0.010 inches), depending on the application. The shortened length S of the body portion 102 is measured from the center of the knob 106 to the bottom of the washer 112 and can be varied from approximately 0.33 inches to 0.53 inches (±0.005 inches). The knob length K of the body portion 102 is measured from the center of the knob 106 to the top of the hip 110 and is typically approximately 0.23 inches.

The knob 106 has a full width A at the top of the knob of approximately 0.187 inches and a shoulder width B where the knob transitions to the shoulder portion 108 of approximately 0.156 inches.

The washer 112 is machined to an approximately 0.25 inch diameter and a depth W of approximately 0.015 inches. By providing the washer 112 under the hip portion 110 of the ball stud 100, the hexagonal corners of the hip portion will not gouge or scratch the panel upon installation.

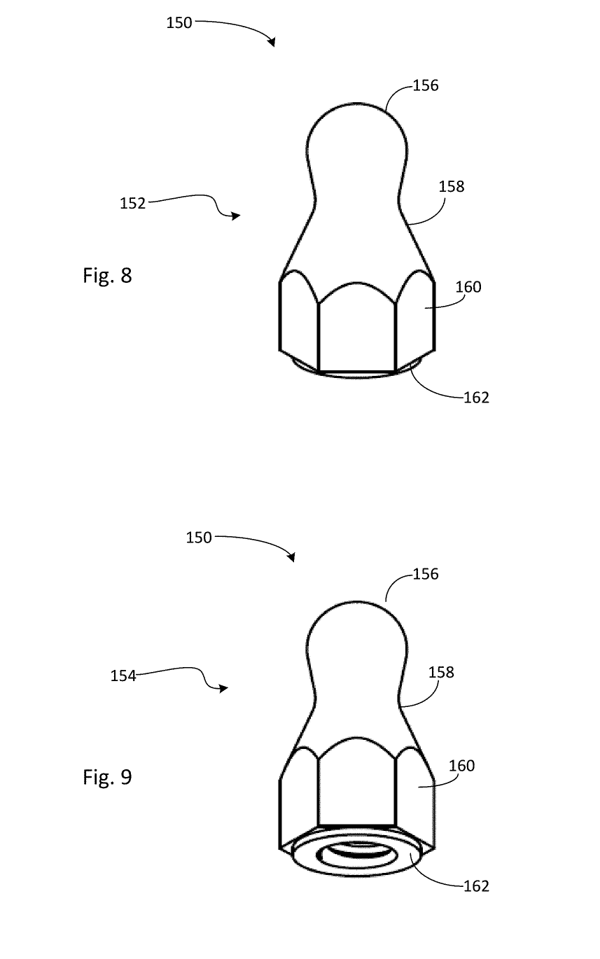

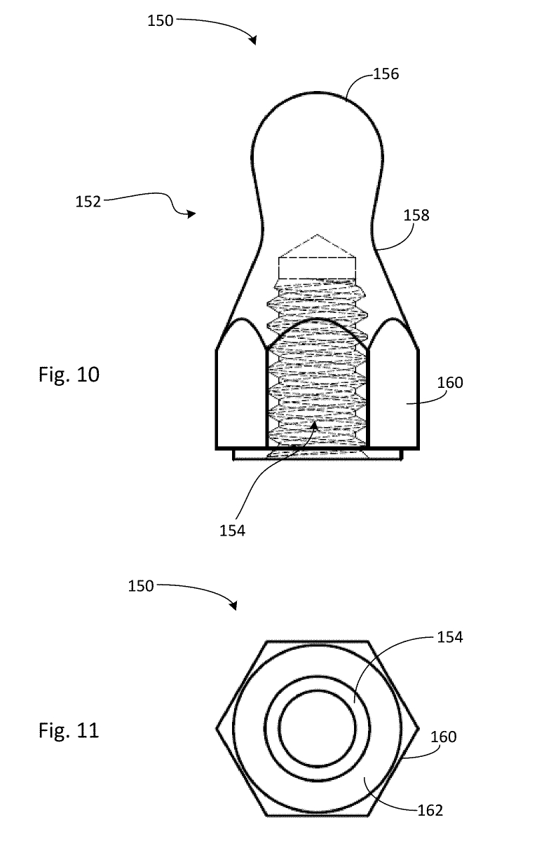

Referring to FIGS. 8-11, a second embodiment of a ball stud 150 in a female configuration is illustrated. Again, the ball stud 150 is preferably a single integrated device machined from a single piece of 0.25 inch hexagonal bar stock. In this embodiment, however, the ball stud 150 includes internal female threads 154 formed inside body portion 152. As in the first embodiment, material is cut away from hex bar stock to form the narrow rounded knob 156 on the top and the wider shoulder portion 158 in the middle that transitions to the hip 160. The flat washer 162 is formed just below the hip 160. The body portion 152 of the ball stud 150 is formed to have the same measurements as the first embodiment.

The internal female threaded portion 154 is formed by tapping the hex stock, either before or after machining the body portion 152.

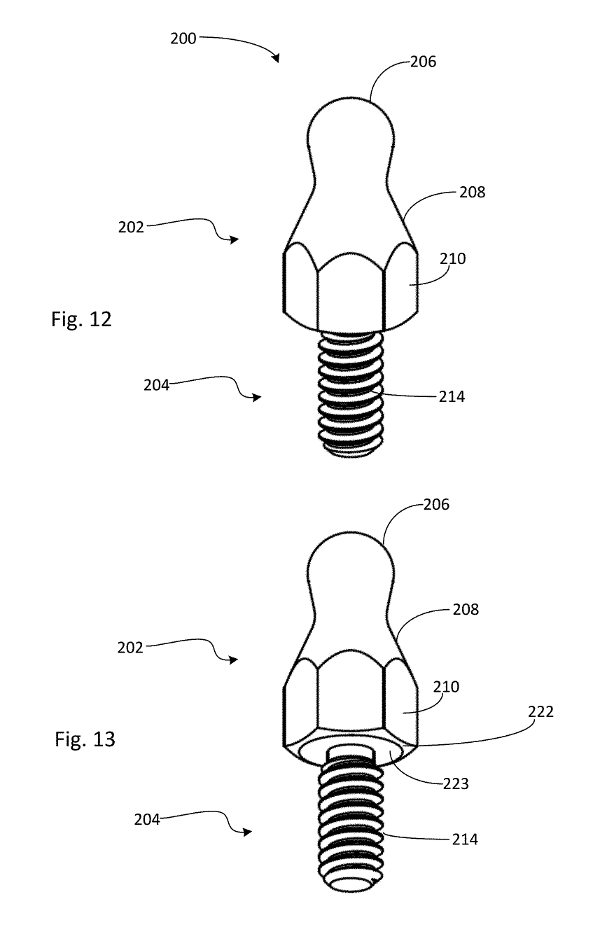

Referring to FIGS. 12-15, a third embodiment of a ball stud 200 in a male configuration is illustrated. As before, the ball stud 200 is preferably a single integrated device machined from a single piece of 0.25 inch hexagonal bar stock to have a body portion 202 with knob 206, shoulder 208 and hip 210, and a thread portion 204 with male threads 214. Overall measurements for the ball stud 200 are similar to the first embodiment.

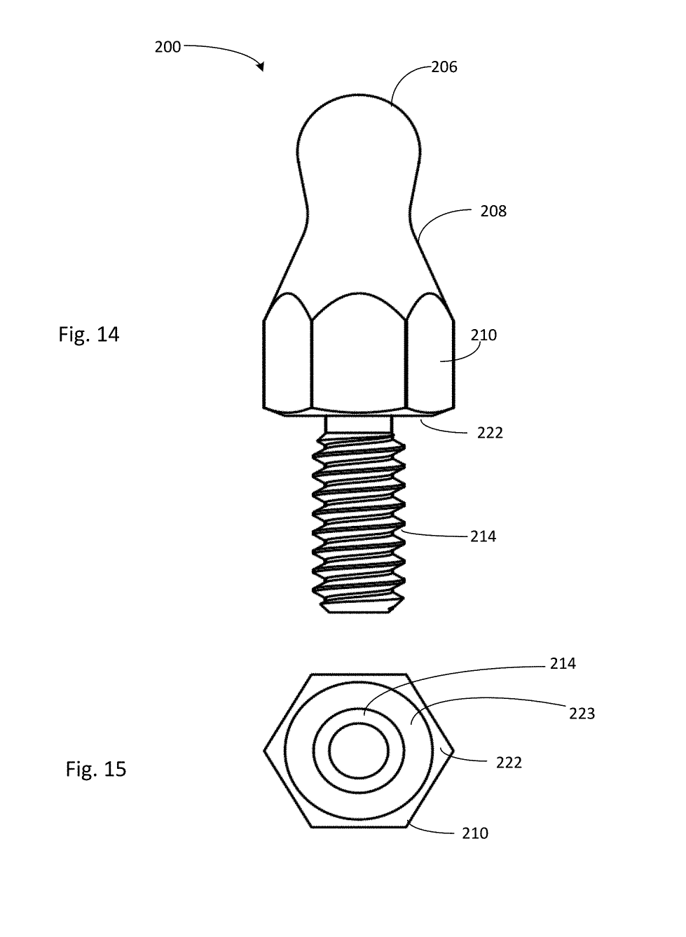

However, in this embodiment, the corners and underside of the hip portion 210 are chamfered, as shown in FIGS. 13-14, to create a symmetrical sloping edge or chamfered portion 222. The chamfered portion 222 is machined to provide an angle of 15-30 degrees sloping away from a flat central portion 223.

By providing a chamfer to the underside and corners of the hip portion 210 of the ball stud 200, the hip portion will not gouge or scratch the panel upon installation.

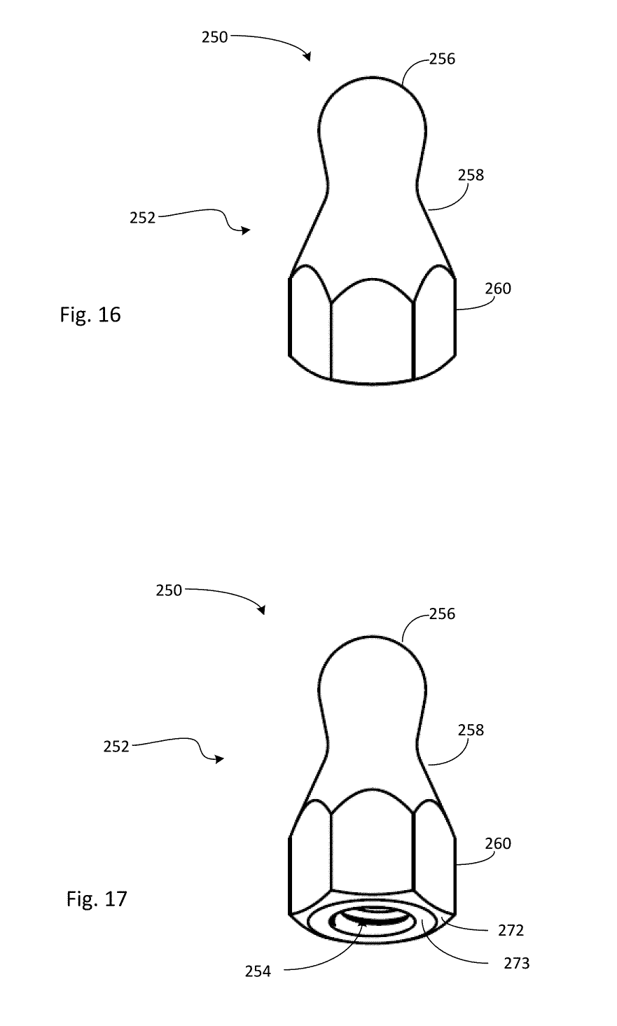

Referring to FIGS. 16-19, a fourth embodiment of a ball stud 250 in a female configuration is illustrated. Once again, the ball stud 250 is preferably a single integrated device machined from a single piece of 0.25 inch hexagonal bar stock to have a body portion 252 with knob 256, shoulder 258 and hip 260. Overall measurements for the body portion 252 of the ball stud 250 are similar to the first embodiment. The internal female threaded portion 254 is formed by tapping the hex stock, either before or after machining the body portion 252.

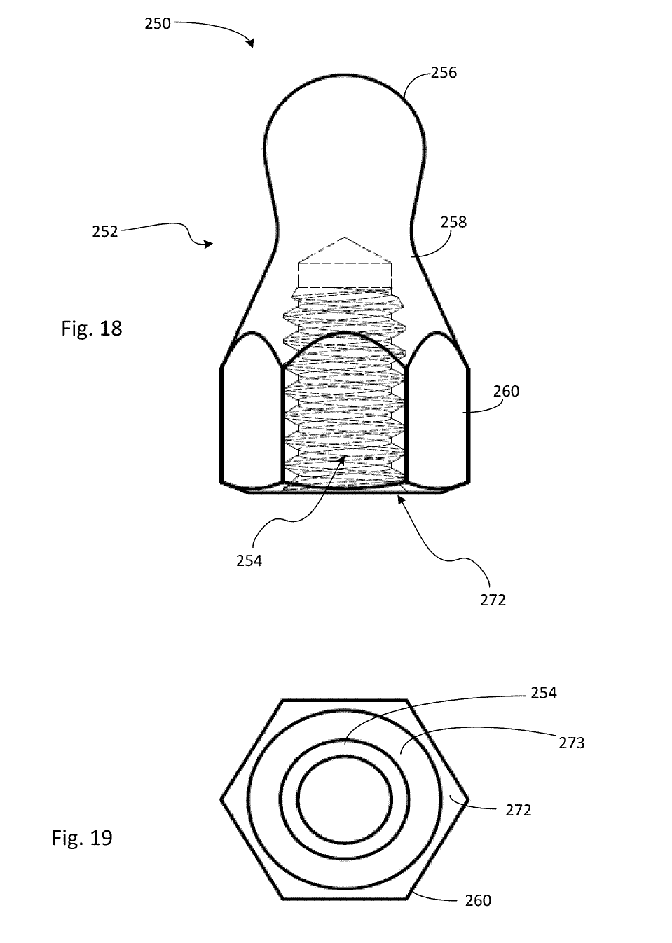

The corners and underside of the hip portion 260 are chamfered, as shown in FIGS. 17-18, to create chamfered portion 272. The chamfered portion 272 is machined to provide an angle of 15-30 degrees sloping away from a flat central portion 273.

Thus, by providing either an integrated washer, or by chamfering the corners, installation of a ball stud can avoid damaging the panel.

While specific embodiments have been described by way of example, it should be understood that the invention is not limited to the disclosed embodiments. To the contrary, this disclosure is intended to cover various modifications and similar arrangements as would be apparent to those skilled in the art. Therefore, the scope of the appended claims should be accorded the broadest interpretation so as to encompass all such modifications and similar arrangements.

1. In a ball stud having a hexagonal hip portion, a rounded knob that is narrower than the hip portion, and a shoulder portion that transitions from the rounded knob to the hip portion, the improvement comprising:
a washer integrated with the ball stud below the hip portion.

2. The ball stud of claim 1, further comprising a male threaded stud extending from the washer.

3. The ball stud of claim 1, further comprising a female threaded portion formed inside the ball stud.

4. In a ball stud having a hexagonal hip portion, a rounded knob that is narrower than the hip portion, and a shoulder portion that transitions from the rounded knob to the hip portion, the improvement comprising:
chamfered corners on the hexagonal hip portion.

5. The ball stud of claim 4, further comprising a male threaded stud extending from the hip portion.

6. The ball stud of claim 4, further comprising a female threaded portion formed inside the ball stud.

7. A ball stud, comprising:
a hip portion having a hexagonal shape;
a rounded knob that is narrower than the hexagonal shape of the hip portion;
a shoulder portion coupling the rounded knob to the hip portion; and
a washer affixed below the hip portion.

8. The ball stud of claim 7, further comprising a male threaded stud extending from the washer.

9. The ball stud of claim 7, further comprising a female threaded portion formed inside the ball stud.

10. The ball stud of claim 7 is machined from a single piece of hexagonal bar stock.

11. A ball stud, comprising:
a hip portion having a hexagonal shape with six corners, wherein the six corners are chamfered;
a rounded knob that is narrower than the hexagonal shape of the hip portion; and
a shoulder portion coupling the rounded knob to the hip portion.

12. The ball stud of claim 11, further comprising a male threaded stud extending from the hip portion.

13. The ball stud of claim 11, further comprising a female threaded portion formed inside the ball stud.

14. The ball stud of claim 11 is machined from a single piece of hexagonal bar stock.
